(19) United States
(12) Patent Application Publication
(10) Pub. No.: US 2005/0146270 A1
(43) Pub. Date: Jul. 7, 2005

(54) Stacked light emitting diode

(76) Inventor: Ying-Ming Ho, Taipei (TW)

Correspondence Address: LighTop Technology Co., Ltd., P.O. Box No. 6-57, Junghe, Taipei, 235, TW

(21) Appl. No.: 10/745,581

(22) Filed: Dec. 29, 2003

(51) Int. Cl. H01J 1/62

(52) U.S. Cl. 313/512

(57) ABSTRACT

A stacked light emitting diode structure includes a light emitting chip fixed at a stand and stacked thereon with one or more than one smaller light emitting chip. Wherein, the light emitting chips have different illumination wavelengths. The invention is characterized that, a lower-layer light emitting chip is a light-transmissive or opaque chip, a second or a third light emitting chip stacked thereon is necessarily a light-transmissive chip, and between the stacked chips is a light-transmissive insulating material for fixing the chips. When putting the aforesaid structure to use, efficacies as better blended light effects and intensity as well as a reduced occupied area are obtained.

### BACKGROUND OF THE INVENTION

(a) Field of the Invention

The invention relates to a stacked light emitting diode, and more particularly, to a light emitting diode capable of emitting multiple colors and formed by two light emitting chips having different wavelengths (illumination colors), with circuits thereof connected in series or in parallel, thereby accomplishing variations of multiple colors and increasing intensity as well as minimizing an occupied area of the chips.

(b) Description of the Prior Art

Referring to FIG. 5A showing a prior multicolor light illuminating diode, two (or three) light emitting diodes a1 and a2 are individually fixed to a stand b (or a circuit board). Electrodes of the light emitting chips a1 and a2 are generally arranged at lower and upper surfaces of the chips. The light emitting chips a1 and a2 have lower surfaces thereof connected to the stand b (or the circuit board) using electrically conductive glue c, and electrodes at upper surfaces thereof conducted with the other electrode at the stand b (or the circuit board) using gold wires or aluminum wires. When electricity is conducted for illumination, for that the light emitting chips a1 and a2 are located at two lateral sides, a greatest shortcoming incurred is that light beams emitted by the two light emitting chips are capable of producing valid blended light effects only at an overlapping middle section as indicated by a sectional area A in FIG. 5, such that blended light effects expected at two sides cannot be produced by the light beams. In addition, during illumination, energies released by the light emitting chips are not totally focused, so that intensity of the light emitting chips appears somewhat inadequate. Furthermore, an occupied area is rather large that trends as being light in weight and small in volume required by modern techniques are left unfulfilled.

Referring to FIG. 6A showing another prior multicolor light emitting diode, the light emitting chips a1 and a2 are arranged at the stand b (or the circuit board) in a stacked manner, and hence a volume thereof is reduced. Yet, the light emitting chip a2 is adhered to the light emitting chip a1 using electrically conductive glue c that is a type of opaque glue, and therefore the light emitting chip a1 serving as a substrate is capable of emitting light beams merely through sides thereof, whereas light beams at an upper surface of the light emitting chip a1 are completed shielded without accomplishing expected blended and condensed light effects as indicated by a sectional area A in FIG. 6. More specifically, a light source is prone to an original color of the upper-layer light emitting chip a2. Also, this prior structure comprising illuminating the chips a1 and a2 hardly offers maximum industrial practicability for that the chips a1 and a2 can only be connected in series.

Referring to FIG. 7A showing yet another light emitting diode, the light emitting chips a1 and a2 are similarly arranged in a stacked manner. However, in order to avoid shortcomings of the prior art shown in FIG. 2, an upper-layer light emitting chip a2 has a smaller volume and is adhered to one lateral side of a lower-layer light emitting chip a1. Although the lower-layer light emitting chip a1 has relatively better illuminating effects, a portion of light beams at the electrically conductive glue c is nevertheless shielded, and blended light beams can only be produced at a middle section as indicated by a sectional area A in FIG. 7B. As a result, the light beams fail to fully achieve blended and condensed light effects. Moreover, the two light emitting chips can only be connected in series supposed they have different video frequencies (VF).

It is apparent from the aforesaid descriptions that, the prior arts lack illuminating effects with completely condensed light beams, with color temperature difference resulted as well. Also, another shortcoming is further occurred for that light intensity produced is smaller than the original light intensity. Above all, restrictions regarding to functions, volumes and appearances of the prior arts are present and thus lowering market competitiveness. It is necessary that the aforesaid shortcomings be advanced.

### SUMMARY OF THE INVENTION

In the view of the aforesaid shortcomings of the prior multi-chip light emitting diode having blended light effects, the invention proposes a novel stacked light emitting diode structure.

The primary object of the invention is to provide a stacked light emitting diode comprising at least two light emitting chips stacked at a stand or a circuit board, thereby accomplishing multicolor variations and high light intensity effects.

The secondary object of the invention is to provide a stacked light emitting diode having minimized light emitting chips for reducing an occupied area, thereby facilitating manufacturing and assembly processes of the structure.

The other object of the invention is to provide a stacked light emitting diode, in that circuits are connected in series or in parallel, thereby expanding product application ranges and efficacies.

To accomplish the aforesaid objects, the invention comprises a light emitting chip having one or more than one light emitting chip of a smaller volume thereon, wherein the light emitting chips have different illumination wavelengths (colors). The invention is characterized that, a lower-layer light emitting chip is a light-transmissive or opaque chip, a second or a third light emitting chip stacked thereon is necessarily a light-transmissive chip, and between the stacked chips is a light-transmissive insulating material for fixing the chips. When putting the aforesaid structure to use, efficacies such as better blended light effects and intensity as well as a reduced occupied area are obtained.

### BRIEF DESCRIPTION OF THE DRAWINGS

FIG. 1 shows a schematic view of an embodiment according to the invention.

FIG. 2 shows a schematic view illustrating blending status of main light beams in FIG. 1.

FIGS. 3A to 3E show various schematic views illustrating feasible arrangements of electrodes of the light emitting chips in various embodiments according to the invention. Wherein, upper views of individual light emitting chips, and upper and side views of stacked light emitting chips of each embodiment are shown.

FIGS. 4A to 4C shows schematic view of another three embodiments according to the invention.

FIGS. 5A and 5B show schematic views of an assembly and a light blending status of a first prior art.

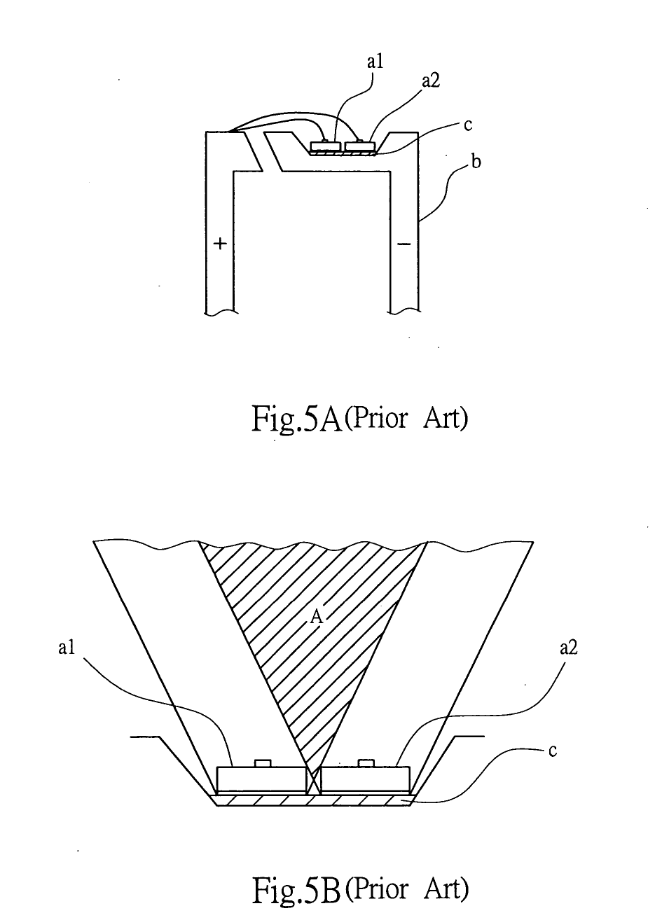

FIGS. 6A and 6B show schematic views of an assembly and a light blending status of a second prior art.

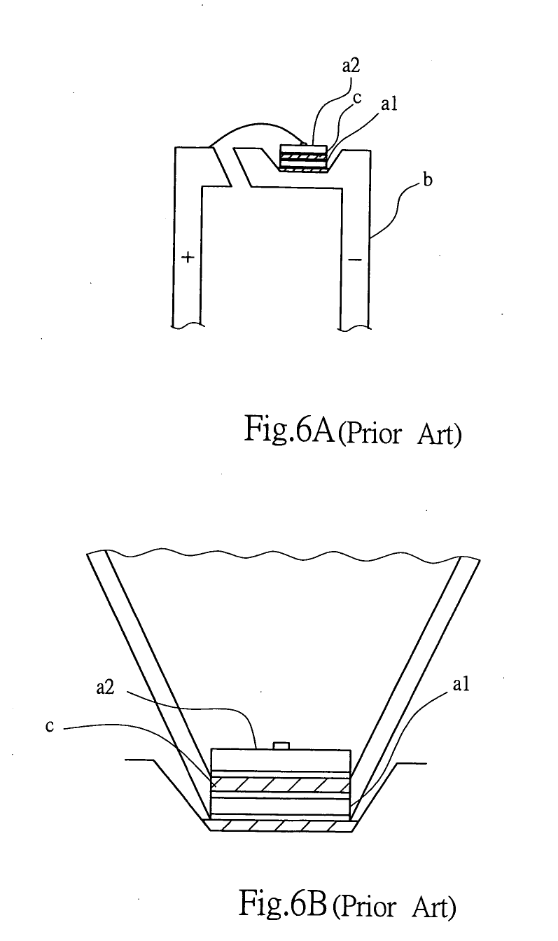

FIGS. 7A and 7B show schematic views of an assembly and a light blending status of a third prior art.

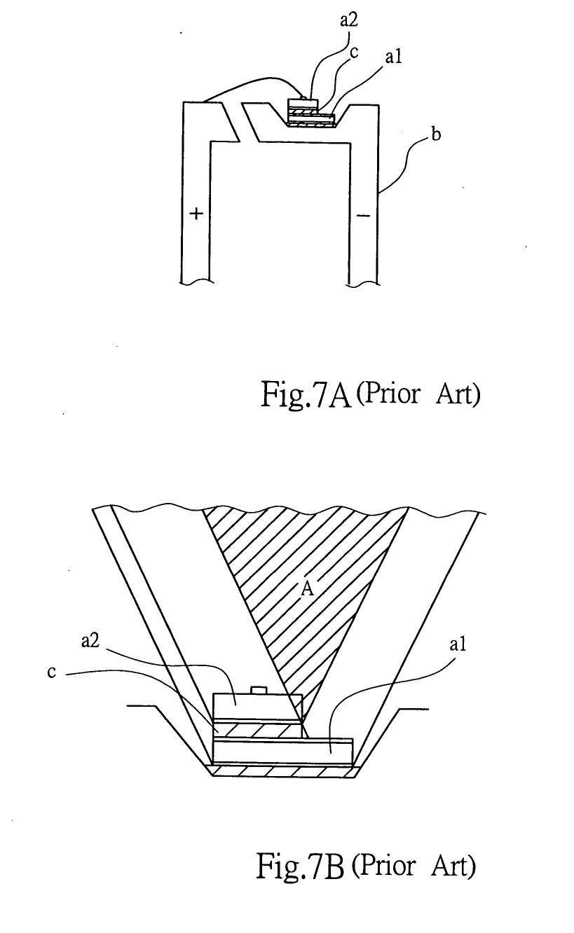

### DETAILED DESCRIPTION OF THE PREFERRED EMBODIMENTS

To better understand structural characteristics and functions of the invention, detailed descriptions shall be given with the accompanying drawings hereunder.

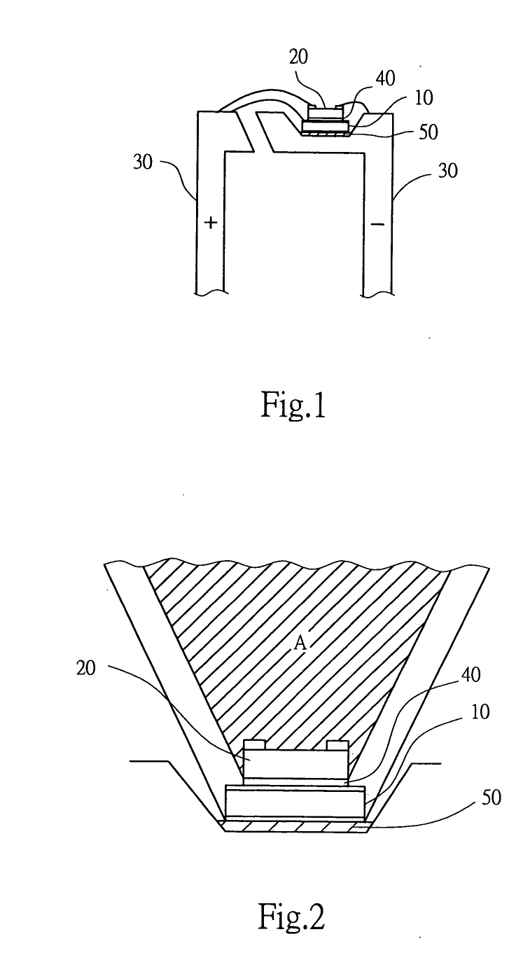

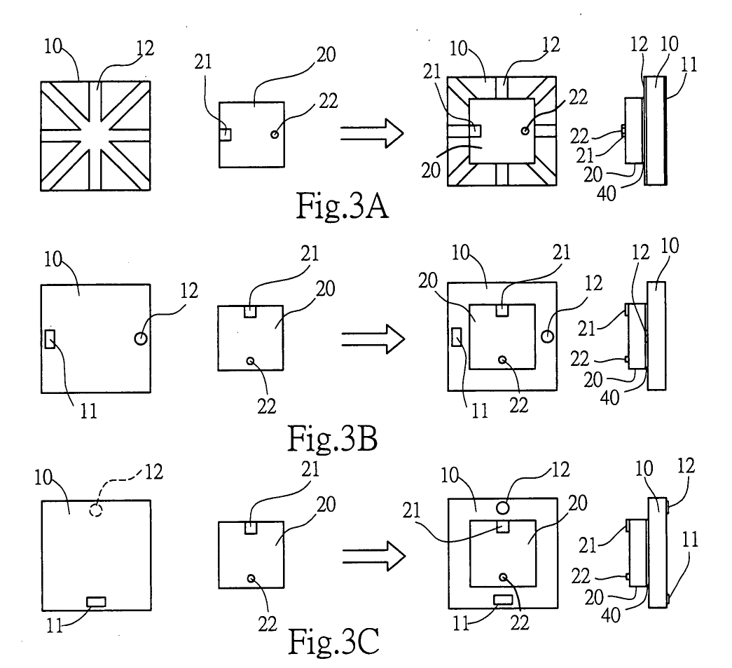

With reference of FIGS. 1 and 2, a stacked light emitting diode according to the invention comprises a light emitting chip 10 fixed at a circuit board or a substrate and stacked with one or more than one light emitting chip 20 thereon. The light emitting chips 10 and 20 have different illumination wavelengths (colors). In conjunction with a CIE hue chart, blended light effects can be achieved by the light emitting chips 10 and 20 having different wavelengths. The invention is characterized that, a lower-layer light emitting chip 10 is a light-transmissive or opaque chip, a second or a third light emitting chip 20 stacked on the thereon is necessarily a light-transmissive chip, and between the stacked chips is a light-transmissive insulating material 40 for fixing the chips.

When putting the aforesaid structure to use, for that the light emitting chips 10 and 20 have different illumination wavelengths (colors), when the chips emit light beams synchronously or asynchronously, light beams emitted by the lower-layer light emitting chip 10 are able pass through the light-transmissive insulating material 40 and the upper-layer light emitting chip 20, thereby producing multicolor blended light effects in an evenly distributed manner within a rather large light blending area as indicated by a sectional area A in FIG. 2. In addition, because one or more than one light emitting chip 20 is spontaneously stacked on the lower-layer light emitting chip 10, an area of the multi-chip light emitting diode occupied at a stand or a circuit board is effectively reduced while also minimizing a volume of the light emitting diode.

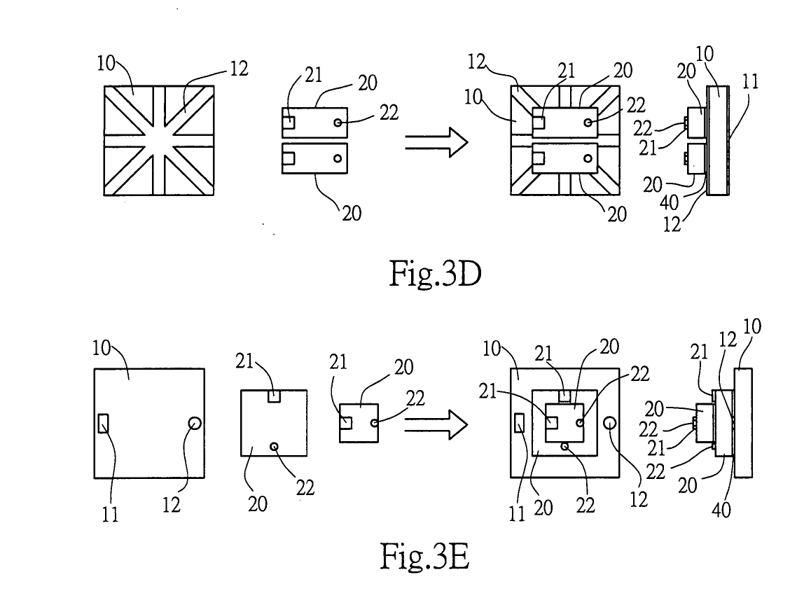

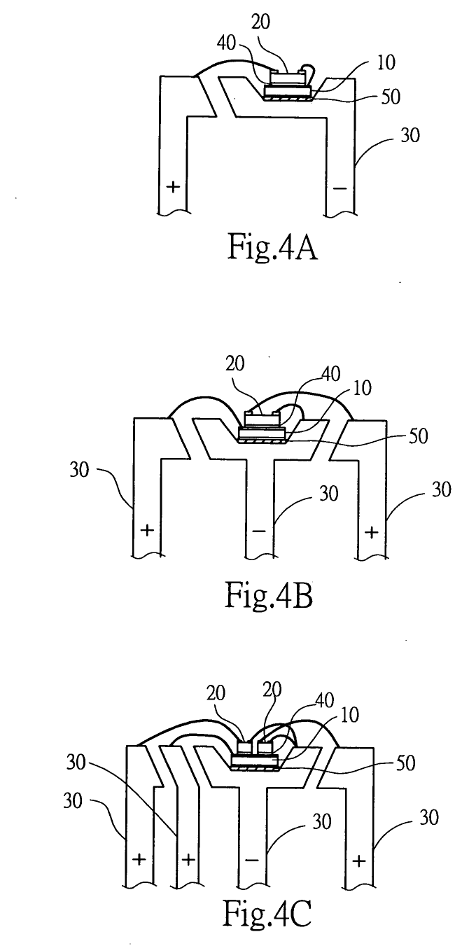

According to the aforesaid structure and referring to FIGS. 3A to 3E, the first-layer lower-layer light emitting chip 10 has positive and negative electrodes 11 and 12 at lower and upper surfaces thereof. The positive and negative electrodes 11 and 12 are connected to positive and negative electrodes of a stand 30 (or a printed circuit board, PCB), respectively. A second-layer or a third-layer light emitting chip 20 having positive and negative electrodes 21 and 22 at an upper end thereof is then stacked onto the lower-layer light emitting chip 10. The stacked light emitting chips 10 and 20 are adhered using transparent insulating glue 40, and are electrically connected in series or in parallel with each other and also with the positive and negative electrodes of the stand 30 using gold wires or aluminum wires as shown in FIGS. 4A to 4C. Hence, synchronous and asynchronous activation controls can be appropriate regulated to accomplish multicolor light blending and volume minimizing purposes.

Again referring to the embodiments shown in FIGS. 1 and 2, the electrode at the lower surface of the lower-layer light emitting chip 10 is directly conducted with the negative electrode of the stand 30 using the electrically conductive glue 50, whereas the other electrode at the upper surface of the lower-layer light emitting diode 10 is conducted with the positive electrode of the stand 30 via a gold wire or an aluminum wire. The two electrodes at the upper surface of the upper-layer light emitting chip 20 are connected to the positive and negative electrodes of the stand 30 using gold wires or aluminum wires, respectively, so as to form a parallel circuit. Wherein, referring to FIG. 3A, the lower-layer light emitting chip 10 has the negative electrode 11 at a lower surface thereof, and the positive electrode 12 in a cross at the upper surface thereof; and the upper-layer light emitting chip 20 has a negative electrode 21 and a positive electrode 22 at two lateral sides of the upper surface thereof, with the negative electrode 21 and the positive electrode 22 connected to the positive and negative electrodes of the stand 30.

Referring to the embodiment shown in FIG. 4A, the electrodes of the various light emitting chips 10 and 20 can also be arranged as in the embodiment shown in FIG. 3A. For assembly, the lower-layer light emitting chip 10 has the electrode at the lower surface thereof directly connected and conducted with the negative electrode of the stand 30, and the other electrode at the upper surface thereof serially connected to an electrode at the upper surface of the light emitting chip 20. The upper-layer light emitting diode 20 has the other electrode at the upper surface thereof connected to the positive electrode of the stand 30 using a gold wire or an aluminum wire, thereby forming a circuit structure in series connection.

Referring to an embodiment shown in FIG. 4B, the electrodes of the various light emitting chips 10 and 20 can also be arranged as in the embodiment shown in FIG. 3A. Furthermore, this embodiment has three stands 30, wherein a negative stand is shared in between and two independent positive stands are located at two sides. For assembly, the lower-layer light emitting chip 10 similarly has the electrode at the lower surface thereof directly conducted with the negative stand 30, and the other electrode at the upper surface thereof conducted with one of the positive stands 30 using a gold wire or an aluminum wire. The upper-layer light emitting chip 20 has two electrodes at the upper surface thereof respectively conducted with the shared negative stand and the other positive stand using gold wires or aluminum wires, thereby forming a parallel negative circuit. Thus, the various light emitting chips 10 and 20 are enabled to illuminate at different timings for increasing color variation effects.

Referring to FIG. 4C showing another embodiment, the electrodes of the various light emitting chips 10 and 20 can also be arranged as in the embodiment shown in FIG. 3D, in which an arrangement of the electrodes of the light emitting chips is modified from that in FIG. 3A. This embodiment has three light emitting chip and four stands 30. Wherein, a shared negative stand is located in between and three independent stands are located at two sides. For assembly, the lower-layer light emitting chip 10 has the electrode at the lower surface thereof directly conducted with the negative stand 30 using electrically conductive glue 50, and the other electrode at the upper surface thereof conducted with one of the positive stands 30 using a gold wire or an aluminum wire. The upper-layer light emitting chip 20 has two electrodes at the upper surface thereof respectively conducted with the shared negative stand and the other two positive stands using gold wires or aluminum wires, thereby forming a parallel positive-negative circuit. Thus, the various light emitting chips 10 and 20 are enabled to illuminate at different timings for increasing color variation effects. Also, light emitting chips having different VF can be used for expanding practical values of products.

Referring to the embodiments shown in FIGS. 3B, 3C and 3E, in the embodiment in FIG. 3B, the lower-layer light emitting chip 10 has a negative electrode 11 and a positive electrode 12 at two sides of the upper surface thereof, so that it is essential for the lower-layer light emitting chip 10 two to adhere the two electrodes thereof to the positive and negative PCB of the circuit board using electrically conductive glue, and then to connect to the upper-layer light emitting chip 20 in series or in parallel using gold wires or aluminum wires. To put the embodiment in FIG. 3D to use, an arrangement of the electrodes of the light emitting chips are modified from that in FIG. 3B. However, the upper-layer light emitting chip 20 in this embodiment is stacked thereon with a third light emitting chip 20 having an even smaller volume above.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A stacked light emitting diode structure comprising a light emitting chip fixed at a stand and stacked thereon with one or more than one smaller light emitting chip; wherein, the light emitting chips have different illumination wavelengths (colors), and in conjunction with an CIE hue chart, blended light effects can be achieved by the light emitting chips having different wavelength; and
being characterized that, a lower-layer light emitting chip is a light-transmissive or opaque chip, a second or a third light emitting chip stacked thereon is necessarily a light-transmissive chip, and between the stacked chips is a light-transmissive insulating material for fixing the chips.

2. A stacked light emitting diode structure in accordance with claim 1, wherein the lower-layer light emitting chip is fixed to a circuit board.

3. A stacked light emitting diode structure in accordance with claim 1, wherein the lower-layer light emitting chip is fixed to a substrate.

4. A stacked light emitting diode structure in accordance with claim 1, wherein the lower-layer light emitting chip has two electrodes thereof disposed to an upper surface thereof.

5. A stacked light emitting diode structure in accordance with claim 1, wherein the lower-layer light emitting chip has two electrodes thereof disposed to a lower surface thereof.

6. A stacked light emitting diode structure in accordance with claim 1, wherein an upper-layer light emitting chip has two electrodes thereof disposed to two lateral sides of an upper surface thereof.
